(19) United States
(12) Patent Application Publication
(10) Pub. No.: US 2025/0378305 A1
(43) Pub. Date: Dec. 11, 2025

(54) KNOWLEDGE BASE SYSTEM BASED ON LARGE LANGUAGE MODEL AND CONSTRUCTING METHOD THEREOF

(71) Applicant: NATIONAL CHENG KUNG UNIVERSITY, Tainan City (TW)

(72) Inventors: Yu-Ming HSIEH, Tainan City (TW); Wei-Yu CHEN, Tainan City (TW); Po-Jui CHEN, Tainan City (TW); Fan-Tien CHENG, Tainan City (TW)

(21) Appl. No.: 19/221,557

(22) Filed: May 29, 2025

Related U.S. Application Data
(60) Provisional application No. 63/654,112, filed on May 31, 2024.

(51) Int. Cl. G06N 3/042; G06F 16/242

(52) U.S. Cl. CPC G06N 3/042; G06F 16/243

(57) ABSTRACT

A knowledge base system based on a large language model includes a processor configured to construct and enable a specific domain function module to perform a function calling mechanism according to the large language model to generate a function corresponding to one of an industrial process monitoring system information and a nature language query information, and establish a knowledge base. The processor is configured to construct and enable a retrieval augmented generation module to perform an embedding transfer mechanism to generate a plurality of embedding vectors, and retrieve embedding vectors and establish a vector store. The processor is configured to construct and enable a knowledge and information management module to manage the knowledge base and the vector store.

### RELATED APPLICATIONS

This application claims priority to U.S. Provisional Application Ser. No. 63/654,112, filed on May 31, 2024, which is herein incorporated by reference.

### BACKGROUND

### Technical Field

The present disclosure relates to a knowledge base system and a constructing method thereof, and more particularly to a knowledge base system and a constructing method thereof based on a large language model (LLM).

### Description of Related Art

In existing conventional factory monitoring systems, the production process may be monitored in real time, and process changes may be captured, and abnormal situations may be reduced. However, after detecting an anomaly, these conventional systems still rely on manual operations or expert experience to provide subsequent improvement suggestions. In practical applications, conventional systems have the following problems that need to be overcome. First, low efficiency: conventional equipment fault diagnosis methods rely on manual experience and have slow processing speed. Second, over-reliance on manual experience: diagnosis and solutions are highly dependent on personal expertise. Third, knowledge accumulation is difficult: there is a lack of effective knowledge management and inheritance mechanisms. Fourth, lack of versatility: existing large-scale language models may not perform well in specific professional fields (such as factory machine maintenance knowledge). Fifth, the hallucination problem: large language models may produce content that is inconsistent with the facts or lacks basis. It can be seen that the market currently lacks a knowledge base system based on a large language model and its construction method that integrates artificial intelligence (AI) technology and can effectively improve the efficiency and accuracy of fault diagnosis. Therefore, relevant industry players are all seeking solutions.

### SUMMARY

In accordance with one embodiment of the structural aspect of the present disclosure, a knowledge base system based on a large language model is provided, which includes a memory and a processor. The memory is configured to store industrial process monitoring system information, nature language query information and a large language model, in which the industrial process monitoring system information is different from the nature language query information. The processor is electrically connected to the memory, and is configured to receive the large language model and one of the industrial process monitoring system information and the nature language query information, and is configured to perform operations including the following steps: performing a specific domain function operation, a retrieval augmented generation operation, and a knowledge and information management operation. The specific domain function operation includes constructing a specific domain function module, enabling the specific domain function module to perform a function calling mechanism according to the large language model to generate a function corresponding to the one of the industrial process monitoring system information and the nature language query information, and establishing a knowledge base. The retrieval augmented generation operation includes constructing a retrieval augmented generation module, enabling the retrieval augmented generation module to perform an embedding transfer mechanism to generate a plurality of embedding vectors, and retrieving at least one of the embedding vectors and establishing a vector store, in which the at least one of the embedding vectors is most relevant to the one of the industrial process monitoring system information and the nature language query information. The knowledge and information management operation includes constructing a knowledge and information management module, enabling the knowledge and information management module to manage the knowledge base and the vector store. The processor generates an answer corresponding to the one of the industrial process monitoring system information and the nature language query information according to the function and at least one of the embedding vectors.

In accordance with one embodiment of the method aspect of the present disclosure, a constructing method of a knowledge base system based on a large language model is provided, which includes the following steps: utilizing a processor to obtain a large language model and one of industrial process monitoring system information and nature language query information from a memory, in which the industrial process monitoring system information is different from the nature language query information; utilizing the processor to perform a specific domain function operation. The specific domain function operation includes constructing a specific domain function module, enabling the specific domain function module to perform a function calling mechanism according to the large language model to generate a function corresponding to the one of the industrial process monitoring system information and the nature language query information, and establishing a knowledge base; utilizing the processor to perform a retrieval augmented generation operation. The retrieval augmented generation operation includes constructing a retrieval augmented generation module, enabling the retrieval augmented generation module to perform an embedding transfer mechanism to generate a plurality of embedding vectors, and retrieving at least one of the embedding vectors and establishing a vector store, in which the at least one of the embedding vectors is most relevant to the one of the industrial process monitoring system information and the nature language query information; and utilizing the processor to perform a knowledge and information management operation. The knowledge and information management operation includes constructing a knowledge and information management module, enabling the knowledge and information management module to manage the knowledge base and the vector store. The processor generates an answer corresponding to the one of the industrial process monitoring system information and the nature language query information according to the function and at least one of the embedding vectors.

### BRIEF DESCRIPTION OF THE DRAWINGS

This disclosure can be more fully understood by reading the following detailed description of the embodiments, with reference made to the accompanying drawings as follows:

FIG. 1 is a block diagram of a knowledge base system based on a large language model in accordance with a first embodiment of the present disclosure.

FIG. 2 is a schematic diagram of a data collection device and a production line of a knowledge base system based on a large language model in FIG. 1.

FIG. 3 is a flow chart of a constructing method of a knowledge base system based on a large language model in accordance with a second embodiment of the present disclosure.

FIG. 4 is a schematic diagram of function modules based on a large language model in accordance with a third embodiment of the present disclosure.

FIG. 5 is a flow chart of a function calling mechanism of a specific domain function module of the present disclosure.

FIG. 6 is a flow chart of an equipment manual retrieval and a question-answer retrieval of a retrieval augmented generation module of the present disclosure.

### DETAILED DESCRIPTION

A plurality of embodiments of the present disclosure may be illustrated below with reference to the accompanying drawings. For the sake of clarity, many practical details are illustrated in the following description. However, it should be noted that these practical details are not intended to limit the present disclosure. That is, in some embodiments of the present disclosure, these practical details are not necessary. In addition, to simplify the drawings, some conventional structures and elements are depicted in the drawings in a simple schematic manner; and repeated elements may be represented by the same reference numerals.

In addition, in the present disclosure, when a certain element (or unit or module, etc.) is “connected” to another element, it may mean that the element is directly connected to the other element, or it may mean that the element is indirectly connected to the other element, that is, there are other elements between the element and the other element. When it is explicitly stated that a certain element is “directly connected to” another element, it means that there are no other elements between the element and the other element. The terms first, second, third, etc. are only utilized to describe different elements but do not limit the elements themselves. Therefore, a first element may also be referred to as a second element. Further, the combination of components/units/circuits herein is not a generally known, conventional or conventional combination in this field, and whether the components/units/circuits themselves are conventional cannot be utilized to determine whether their combination relationship may be easily completed by a person of ordinary skill in the technical field.

The present disclosure proposes an innovative knowledge base system framework based on a large language model (LLM), aiming to solve the problem of over-reliance on manual experience and expert knowledge for equipment fault diagnosis in modern factories. This system framework integrates artificial intelligence technologies, including large language models, specific domain functions (SDF), retrieval augmented generation (RAG), and knowledge and information management (KIM). The system architecture is divided into demand layer, transport layer and application layer, which may realize end-to-end automated processing from user query to equipment abnormality diagnosis. The core advantage of this system framework lies in its flexibility and scalability. The specific domain function module provide a variety of functional plug-ins, such as: fault detection and classification chart acquisition, maintenance suggestions and alarm code definition, etc. The retrieval augmented generation module includes sub-modules such as embedding transfer mechanism, equipment manual retrieval and question-answer retrieval, which may retrieve required information from different data sources. This setup enables the system to provide users with more precise and professional solutions while reducing reliance on manual experience. Through application verification in the fault detection and classification (FDC) system and equipment maintenance in semiconductor bumping factories, this system framework demonstrates its effectiveness in answering FDC system questions and providing equipment maintenance suggestions. This provides an effective solution for equipment maintenance in smart manufacturing, and is expected to improve factory operational efficiency and product quality. The present disclosure is not only applicable to the semiconductor industry, but may also be extended to other manufacturing fields, providing strong support for achieving the zero-defect smart manufacturing goal of Industry 4.1.

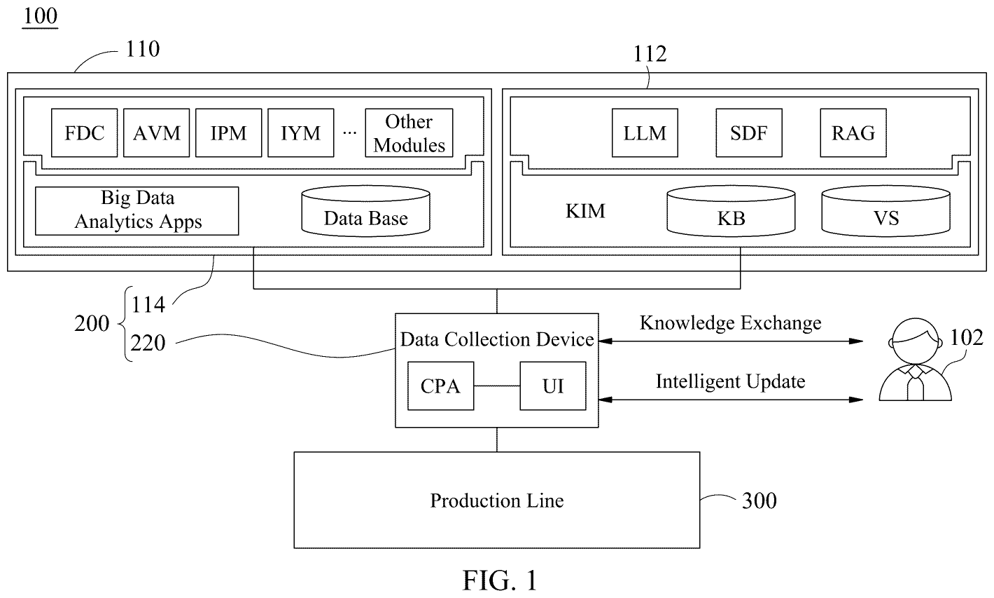

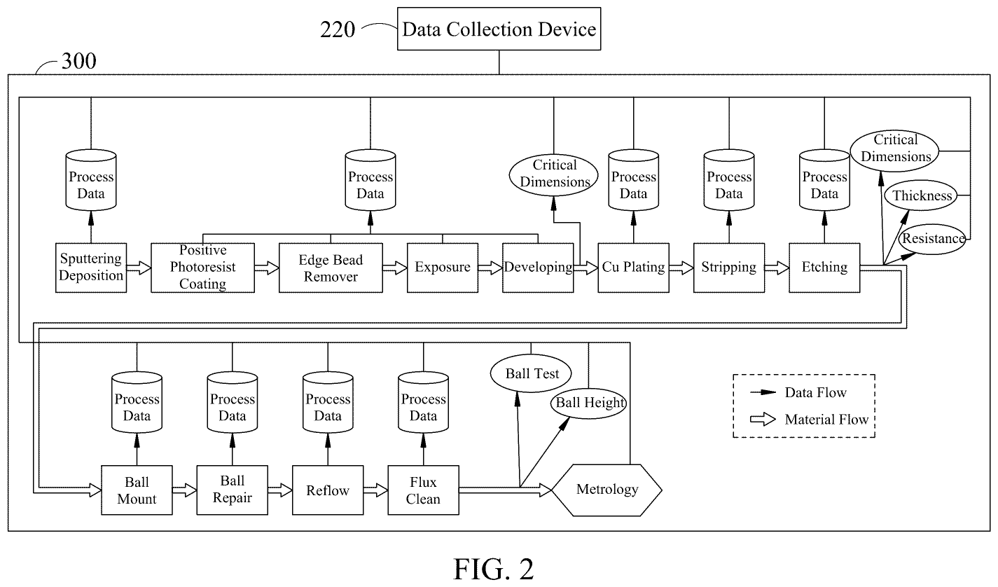

Please refer to FIG. 1 and FIG. 2, in which FIG. 1 is a block diagram of a knowledge base system 100 based on a large language model in accordance with a first embodiment of the present disclosure; and FIG. 2 is a schematic diagram of a data collection device 220 and a production line 300 of the knowledge base system 100 based on a large language model in FIG. 1. The knowledge base system 100 based on a large language model includes a processing device 110. The processing device 110 includes a memory and a processor. The memory stores industrial process monitoring system information, nature language query information and a large language model LLM. The industrial process monitoring system information is different from the nature language query information. The processor is electrically connected to the memory, and receives the large language model LLM and one of the industrial process monitoring system information and the nature language query information, and is configured to implement operations including the following steps: performing an operation of a specific domain function (SDF), an operation of a retrieval augmented generation (RAG), and an operation of a knowledge and information management (KIM). The operation of the specific domain function SDF includes constructing a specific domain function module (SDF module), enabling the specific domain function module to perform a function calling mechanism according to the large language model LLM to generate a function corresponding to the industrial process monitoring system information and the nature language query information, and establishing a knowledge base KB. The operation of retrieval augmented generation includes constructing a retrieval augmented generation module (RAG module), enabling the retrieval augmented generation module to perform an embedding transfer to generate a plurality of embedding vectors, and retrieve at least one of the embedding vectors, and establish a vector store VS. The at least one of the embedding vectors is most relevant to the one of the industrial process monitoring system information and the nature language query information. The operation of the knowledge and information management KIM includes constructing a knowledge and information management module (KIM module), enabling the knowledge and information management module to manage the knowledge base KB and the vector store VS. The processor generates an answer corresponding to the industrial process monitoring system information and the nature language query information according to the function and at least one of the embedding vectors.

In specific, the processing device 110 constructs a knowledge base platform 112 based on a large language model and an Internet of Things (IoT) cloud service platform 114. The knowledge base platform 112 based on a large language model includes a large language model LLM, a specific domain function module (SDF module), a retrieval enhancement generation module (RAG module) and a knowledge and information management module (KIM module). The IoT cloud service platform 114 may be an Advanced Manufacturing Cloud of Things (AMCoT) service platform.

The knowledge base system 100 based on a language model further includes an industrial process monitoring system 200 and a production line 300. The industrial process monitoring system 200 is connected to a memory and a processor, and is utilized to transmit industrial process monitoring system information to the memory. The industrial process monitoring system 200 includes the IoT cloud service platform 114 and the data collection device 220. The data collection device 220 is connected to the memory and the processor, and includes a cyber physical agent CPA and a user interface UI. The cyber physical agent CPA is utilized to collect industrial process monitoring system information. The user interface UI is connected to the cyber physical agent CPA. The user interface UI is utilized to collect nature language query information and transmit the nature language query information to the memory through the cyber physical agent CPA. The production line 300 is connected to the cyber physical agent CPA of the data collection device 220, and includes at least one equipment. The industrial process monitoring system 200 monitors the at least one equipment of the production line 300 through the cyber physical agent CPA to generate the industrial process monitoring system information.

The aforementioned industrial process monitoring system information includes a fault detection and classification (FDC) alarm data. The industrial process monitoring system 200 includes a fault detection and classification (FDC) system of a semiconductor bump process. The fault detection and classification alarm data comes from the fault detection and classification (FDC) system of the semiconductor bump process. The nature language query information includes a natural language query question from the user interface UI; in other words, the user 102 may input the question to be asked through the user interface UI to realize intelligent update of the knowledge base and knowledge exchange mechanism. The industrial process monitoring system information and the nature language query information may be regarded as question data to be asked. The large language model (LLM) includes a generative pre-trained transformer (GPT). Any one of the specific domain function module (SDF module), the retrieval enhancement generation module (RAG module), and the knowledge and information management module (KIM module) is a software module.

In this embodiment, the knowledge base system 100 based on a large language model may be regarded as a system framework. The processing device 110 is signal-connected to the data collection device 220, and the data collection device 220 is signal-connected to the user 102 and the production line 300. The processing device 110 may be regarded as a cloud platform, which is configured to implement the constructing method SO of the knowledge base system based on a large language model. In the industrial process monitoring system 200, the IoT cloud service platform 114 includes smart services of Industry 4.1; the smart services of Industry 4.1 include fault detection and classification (FDC), automatic virtual metrology (AVM), intelligent predictive maintenance (IPM), intelligent yield management (IYM) and other modules. The industrial process monitoring system 200 may be an intelligent factory automation (IFA) system platform.

The aforementioned memory and processor may be a cloud memory and a cloud processor, respectively. The cloud memory may include a random access memory (RAM) or other types of dynamic storage devices that can store information and instructions for execution by the cloud processor. The above information and instructions include large language model LLM, knowledge base KB, vector store VS, big data analytics applications and data base. The cloud processor may include any type of processor, microprocessor, or field programmable gate array (FPGA) that can compile and execute instructions. The cloud processor may include a single device (e.g., a single core) or a group of devices (e.g., multiple cores), but the disclosure is not limited thereto. In addition, the cyber physical agent CPA may refer to the previous U.S. Pat. No. 10,618,137 B2. That is, the embodiments of the present disclosure refer to the relevant provisions of this U.S. patent case (Incorporated by reference).

As can be seen from FIG. 2, in semiconductor packaging technology, the bumping process may be a under bump metallurgy process, which includes sputtering (such as sputtering deposition process), masking (such as positive photoresist coating process, edge bead remover process, exposure process, developing process), electroplating (such as Cu plating process), stripping (such as photoresist removal process), etching (such as etching process), ball mount process, ball repair process, reflow process, flux clean process and metrology. The information generated during the process (such as process data, critical dimensions (CD), thickness (THK), resistance (RS), ball test, ball height, and inspection measurement results) may be transmitted to the cyber physical agent CPA of the data collection device 220 for subsequent use.

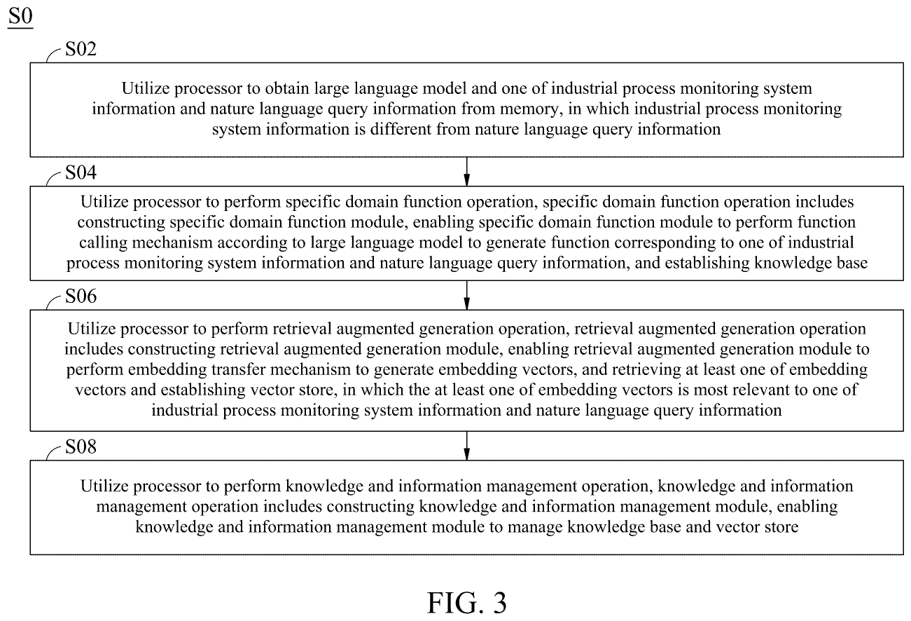

Please refer to FIG. 1, FIG. 2 and FIG. 3, in which FIG. 3 is a flow chart of a constructing method SO of a knowledge base system based on a large language model in accordance with a second embodiment of the present disclosure. The constructing method SO of the knowledge base system based on a large language model includes Steps S02, S04, S06, and S08. Step S02 includes utilizing a processor to obtain a large language model LLM and one of industrial process monitoring system information and nature language query information from a memory, in which the industrial process monitoring system information is different from the nature language query information. Step S04 includes utilizing the processor to perform a specific domain function (SDF) operation. The specific domain function (SDF) operation includes constructing a specific domain function module (SDF module), enabling the specific domain function module to perform a function calling mechanism according to the large language model LLM to generate a function corresponding to the one of the industrial process monitoring system information and the nature language query information, and establishing a knowledge base KB. Step S06 includes utilizing the processor to perform a retrieval augmented generation (RAG) operation. The retrieval augmented generation (RAG) operation includes constructing a retrieval augmented generation module (RAG module), enabling the retrieval augmented generation module to perform an embedding transfer mechanism to generate a plurality of embedding vectors, and retrieving at least one of the embedding vectors and establishing a vector store VS, in which the at least one of the embedding vectors is most relevant to the one of the industrial process monitoring system information and the nature language query information. Step S08 includes utilizing the processor to perform a knowledge and information management (KIM) operation. The knowledge and information management (KIM) operation includes constructing a knowledge and information management module (KIM module), enabling the knowledge and information management module to manage the knowledge base KB and the vector store VS. The processor generates an answer corresponding to the one of the industrial process monitoring system information and the nature language query information according to the function and at least one of the embedding vectors.

Thereby, the knowledge base system 100 based on a large language model and the constructing method SO thereof of the present disclosure may realize end-to-end automated processing from user query to equipment abnormality diagnosis, and provide users with more accurate and professional solutions while reducing dependence on manual experience. Further, the present disclosure integrates artificial intelligence technology into the manufacturing process to provide solutions for equipment maintenance, which may effectively improve operating efficiency and product quality of the factory, and is suitable for the semiconductor industry and related manufacturing fields.

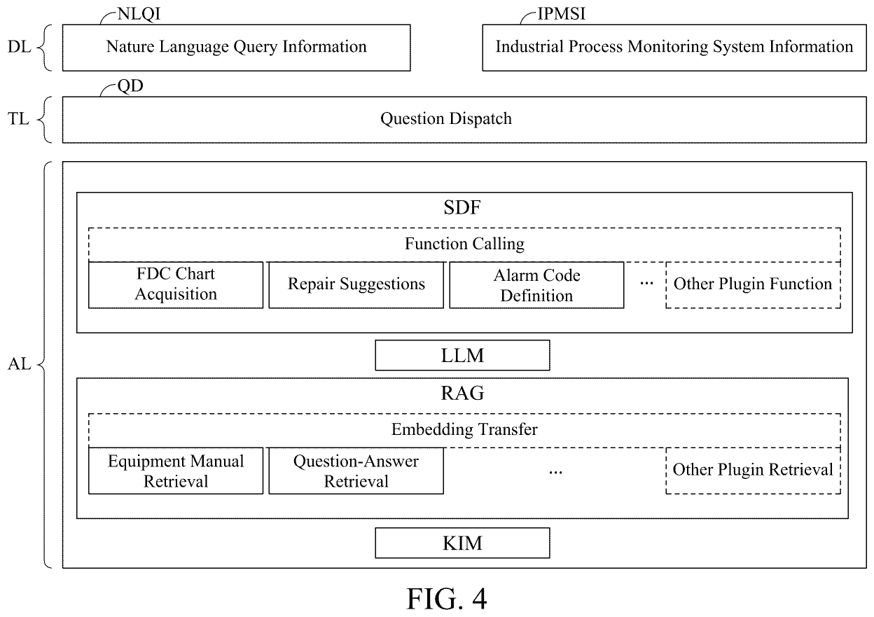

Please refer to FIG. 1, FIG. 2, FIG. 3, and FIG. 4, in which FIG. 4 is a schematic diagram of function modules based on a large language model in accordance with a third embodiment of the present disclosure. The knowledge base system 100 based on a large language model includes a processing device 110, a data collection device 220, and a production line 300. The processing device 110 includes a memory and a processor. The processing device 110 constructs a knowledge base platform 112 based on a large language model and an IoT cloud service platform 114. The memory stores industrial process monitoring system information (IPMSI), nature language query information (NLQI) and a large language model LLM. The industrial process monitoring system information is different from the nature language query information. The processor is electrically connected to the memory, and the processor receives the large language model LLM and the one of the industrial process monitoring system information IPMSI and the nature language query information NLQI.

The processor receives the industrial process monitoring system information IPMSI and the nature language query information NLQI through one of a first method and a second method to form a demand layer DL, and the first method is different from the second method. In specific, the first method includes utilizing natural language to query through the user interface UI to obtain the required questions. The second method includes querying through an alarm of the industrial process monitoring system 200 to obtain the demand question.

The processor forwards the one of the industrial process monitoring system information IPMSI and the nature language query information NLQI to the specific domain function module or the retrieval augmented generation module according to a question dispatch mechanism (QD mechanism) to form a transfer layer TL.

The processor performs a function calling mechanism or an embedding transfer mechanism for the industrial process monitoring system information IPMSI and the nature language query information NLQI according to the specific domain function module or the retrieval augmented generation module to form an application layer AL.

Thus, the specific domain function module (SDF module) of the present disclosure may provide multiple functional plugins, such as fault detection and classification (FDC) chart acquisition, repair suggestion, alarm code definition, etc. These functions may be quickly accessed through the function calling mechanism, and interfaces of other plugins functions may be retained. In addition, the retrieval augmented generation module (RAG module) may include sub-modules such as embedding transfer mechanism, equipment manual retrieval, and question-answer retrieval. The retrieval augmented generation module may retrieve the required information from different data sources and provide an interface for other plugin retrieval.

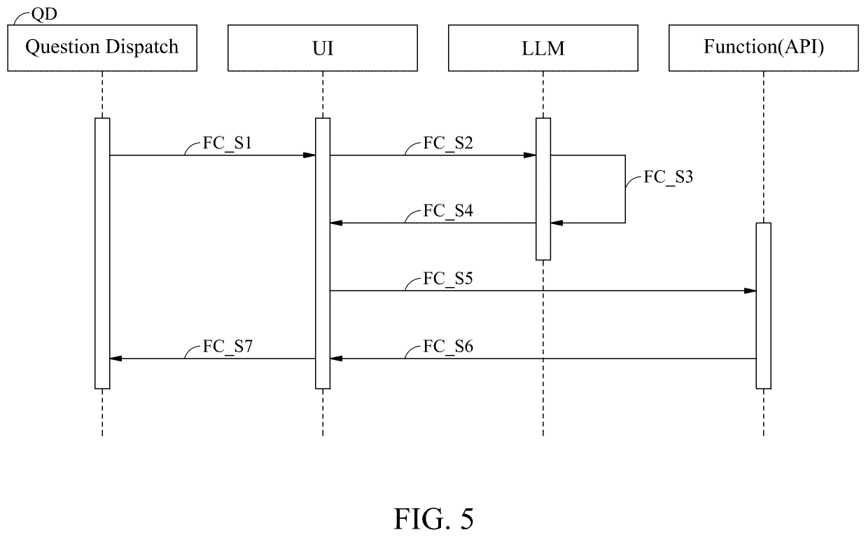

Please refer to FIG. 1, FIG. 2, FIG. 3, FIG. 4, and FIG. 5, in which FIG. 5 is a flow chart of a function calling mechanism of a specific domain function module (SDF module) of the present disclosure. The function calling mechanism of the specific domain function module includes performing operations FC_S1, FC_S2, FC_S3, FC_S4, FC_S5, FC_S6, and FC_S7. The operation FC_S1 includes receiving industrial process monitoring system information IPMSI and nature language query information NLQI from a question dispatch (QD) mechanism through a user interface UI. The operation FC_S2 includes transmitting the one of the industrial process monitoring system information IPMSI and the nature language query information NLQI to the function calling mechanism of a large language model LLM in a data format through the user interface UI. The operation FC_S3 includes evaluating the function that can be used through the function calling mechanism of the large language model LLM. The operation FC_S4 includes notifying the user interface UI of the function that can be used in a data format through the function calling mechanism of the large language model LLM. The operation FC_S5 includes calling the function that can be used through the user interface UI, in which the function that can be used is a fault detection and classification (FDC) chart acquisition function. The operation FC_S6 includes receiving a return result through the user interface UI. The operation FC_S7 includes sending the return result back to the question dispatch (QD) mechanism through the user interface UI. In one embodiment of the present disclosure, the data format may include a JSON format, but the present disclosure is not limited thereto.

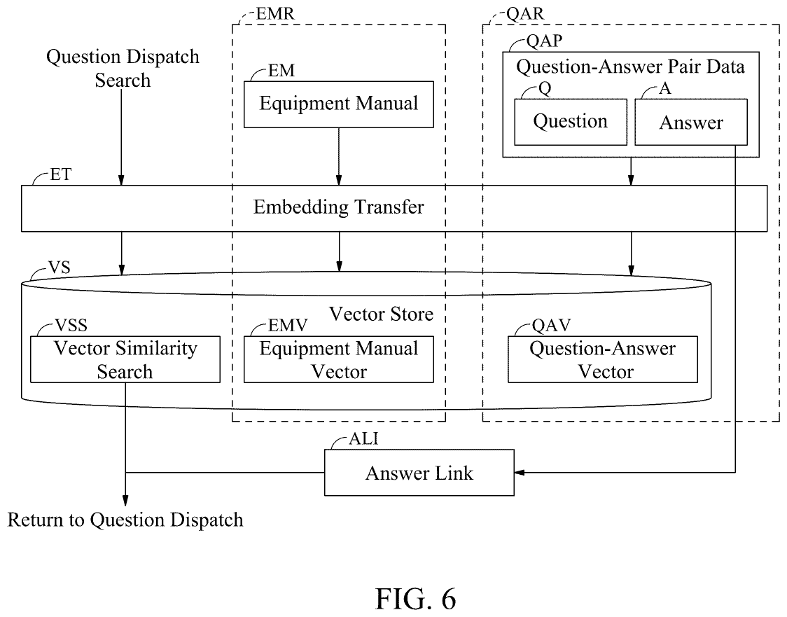

Please refer to FIG. 1, FIG. 2, FIG. 3, FIG. 4, and FIG. 6, in which FIG. 6 is a flow chart of an equipment manual retrieval EMR and a question-answer retrieval QAR of a retrieval augmented generation (RAG) module of the present disclosure. In the constructing method SO of the knowledge base system based on a large language model of the present disclosure, the operation of retrieval augmented generation (RAG) may further include performing an equipment manual retrieval EMR and a question-answer retrieval QAR. The equipment manual retrieval EMR includes performing an embedding transfer ET on an equipment manual EM according to a retrieval augmented generation module to generate an equipment manual vector set EMV of these embedding vectors. The embedding transfer ET includes converting a text data into an embedding vector data. Further, the question-answer retrieval QAR includes performing an embedding transfer ET on a question-answer pair data QAP according to the retrieval augmented generation module to generate a question-answer vector set QAV of these embedding vectors. The question-answer pair data QAP includes a plurality of questions Q and a plurality of answers A. The vector store VS includes the equipment manual vector set EMV and the question-answer vector set QAV of these embedding vectors. The processor performs a vector similarity search VSS according to the vector store VS, and utilizes the answer link ALI to establish a relationship between the question and the answer, so as to retrieve the answer corresponding to the one of the industrial process monitoring system information IPMSI and the nature language query information NLQI.

Please refer to FIG. 1, Table 1 and Table 2, in which Table 1 shows a first question-answer embodiment of the knowledge base system 100 based on a large language model of the present disclosure, and Table 2 shows the first question-answer embodiment of a conventional system. The first question-answer embodiment is applied to equipment maintenance instruction verification. When the user 102 asks the system “How do I repair eqp_name: SPUT_01, sensor: MOTOR_3T1, indicator: Mean, FDC Alarm?”, the knowledge base system 100 based on a large language model of the present disclosure provides specific three-step repair suggestions, including checking the pipeline, checking the filter element of the filter barrel, and checking the etching 1 washing motor. The conventional system only provides general answers.

TABLE 1
Answer from the proposed framework
(suggestions for machine repair):

1. Check the pipelines. Clean the pipelines if there is any crystallization
blockage.
2. Check the filter cartridge of the filter bucket. Replace with a new one
if it has not been replaced regularly.
3. Check the Etching 1 Washing Motor. Replace the motor if abnormal
rotation, operation failure, current overload, or electric relay
tripping occurs.

TABLE 2
Answer from ChatGPT 3.5:

For the equipment E0104584, with the sensor MOTOR_3T1 and the
indicator Mean's FDC alarm, the repair steps may vary depending
on the specific situation. Here are some general suggestions:
Confirm Alarm Details: First, you need to confirm the specific content and
status of the alarm. This may include the exact time of the alarm,
its duration, frequency, etc.
Inspect Equipment: Check if the equipment E0104584 has any visible
physical damage or abnormalities. This may include damaged elements,
unusual sounds, excessive heat, etc.
Check Sensor: Verify whether the MOTOR_3T1 sensor is operating
correctly. You may need to use specialized tools or software to test
the sensor's readings.
Analyze Data: Analyze the data of the Mean indicator to identify any
potential anomalies or trends. This may require specialized data
analysis tools or software.
Repair or Replace: Based on your findings, you may need to repair or
replace damaged elements, or adjust the equipment settings.
Please note that these are general suggestions. Specific repair steps may
need to be adjusted based on the equipment model, the type of alarm, and
your technical knowledge. If you are unsure how to proceed, it is
recommended to contact the equipment manufacturer or a professional
technician. I hope this information is helpful to you!

Please refer to FIG. 1, Table 3 and Table 4, in which Table 3 shows a second question-answer embodiment of the knowledge base system 100 based on a large language model of the present disclosure, and Table 4 shows the second question-answer embodiment of a conventional system. The second question-answer embodiment is applied to the response capability of the equipment professional knowledge. When the user 102 asks the system “What is the set temperature range of the etching tank?”, the knowledge base system 100 based on a large language model of the present disclosure provides a clear value range “The set temperature of the etching tank shall not exceed 1° C.”. The conventional system only provides general answers.

TABLE 3
Answer from the proposed framework:

The etching tank setting temperature must not exceed 1° C.

TABLE 4
Answer from ChatGPT 3.5:

The temperature range setting for the etching tank will vary depending on
the etching solution and the material being etched. For example, when
using potassium hydroxide (KOH) as, the etching solution the etching rate
increases with rising temperature. However, excessively high temperatures
may cause an imbalance in the chemical composition of the etching
solution or damage the corrosion-resistant layer. Therefore, the
temperature of the etching solution is usually controlled within the range
of 40 to 50 C. On the other hand, when using acidic copper chloride
etching solution, the temperature is generally controlled within the range
of 45 to 55 C. Please determine the most suitable temperature range based
on your specific needs and experimental conditions.

It can be seen from the aforementioned first question-answer embodiment and the aforementioned second question-answer embodiment that the system framework of the present disclosure may provide a more targeted, more professional and more feasible solution. Compared with conventional large language models (such as ChatGPT3.5), the answers of the system of the present disclosure are more concise, direct, and more suitable for use by factory operators. Through this implementation, the present disclosure integrates artificial intelligence technology into the manufacturing process, provides an effective solution for equipment maintenance, and effectively improves operating efficiency and product quality of factories. In addition, compared with the conventional technology, the present disclosure has the following distinctive features: (1) integrating multiple artificial intelligence technologies instead of relying on a single model or system. (2) solving the problem of insufficient knowledge in specific fields of large language models through RAG technology. (3) providing an extensible plugin architecture to meet the needs of different factories and industries. (4) realizing end-to-end automated processing from user query to equipment diagnosis. (5) having the ability to continuously learn and update knowledge to continuously improve system performance.

It is understandable that the constructing method SO of the knowledge base system based on a large language model of the present disclosure is the implementation steps described above, and the computer program product of the present disclosure is utilized to complete the constructing method SO of the knowledge base system based on a large language model as described above. The order of the implementation steps described in the above embodiments may be adjusted, combined or omitted according to actual needs. The above embodiments may be implemented utilizing a computer program product, which may include a machine-readable medium storing a plurality of instructions. These instructions may program a computer to perform the steps in the above embodiments. The machine-readable medium may be, but is not limited to, a floppy disk, an optical disk, a CD-ROM, a magneto-optical disk, a read-only memory, a random access memory, an erasable programmable read-only memory (EPROM), an electronically erasable programmable read-only memory (EEPROM), an optical or magnetic card, a flash memory, or any machine-readable medium suitable for storing electronic instructions. Further, embodiments of the present disclosure may also be downloaded as a computer program product, which may be transferred from a remote computer to a requesting computer utilizing a data signal over a communications link (e.g., a network connection).

It should also be noted that the present disclosure may also be described in the context of a manufacturing system. Although the present disclosure may be implemented in semiconductor manufacturing, the present disclosure is not limited to semiconductor manufacturing, and may also be applied to other manufacturing industries (such as panel industry, packaging and testing industry, and paper industry). The manufacturing system is configured to manufacture workpieces or products including but not limited to microprocessors, memory devices, digital signal processors, application specific circuits (ASICs), or other similar devices. The present disclosure may also be applied to other workpieces or products besides semiconductor devices, such as vehicle wheel frames and screws. The manufacturing system includes one or more processing tools that may be utilized to form one or more products or portions of products on or in a workpiece (e.g., wafer, glass substrate). It should be appreciated by those skilled in the art that the processing tools may be of any number and type, including lithography machines, deposition machines, etching machines, grinding machines, annealing machines, machine tools, and the like. In embodiments, the manufacturing system also includes a scatterometer, an ellipsometer, a scanning electron microscope, and the like.

As can be seen from the above description, the knowledge base system and the constructing method of the present disclosure have the following advantages: first, the present disclosure integrates artificial intelligence technology including large language model (LLM), specific domain function (SDF), retrieval augmented generation (RAG) and knowledge and information management (KIM) into the manufacturing process, providing solutions for equipment maintenance, which may effectively improve operating efficiency and product quality of factories, and is suitable for the semiconductor industry and related manufacturing fields. Second, the present disclosure may achieve end-to-end automated processing from user query to equipment abnormality diagnosis, and provide users with more accurate and professional solutions, while reducing dependence on manual experience to solve the problem of conventional factories relying too much on manual experience and expert knowledge for equipment maintenance. Third, by achieving effective accumulation, management and utilization of knowledge, the present disclosure may significantly improve equipment maintenance efficiency and reduce equipment downtime, thereby improving overall production quality and providing strong support for achieving the zero-defect smart manufacturing goal of Industry 4.1.

It will be apparent to those skilled in the art that various modifications and variations can be made to the structure of the present disclosure without departing from the scope or spirit of this disclosure. In view of the foregoing, it is intended that the present disclosure cover modifications and variations of this disclosure provided they fall within the scope of the following claims.

What is claimed is:

1. A knowledge base system based on a large language model, comprising:
a memory configured to store industrial process monitoring system information, nature language query information and the large language model, wherein the industrial process monitoring system information is different from the nature language query information;
a processor electrically connected to the memory, configured to receive the large language model and one of the industrial process monitoring system information and the nature language query information, and configured to perform operations comprising following steps:
performing a specific domain function operation, the specific domain function operation comprising constructing a specific domain function module, enabling the specific domain function module to perform a function calling mechanism according to the large language model to generate a function corresponding to the one of the industrial process monitoring system information and the nature language query information, and establishing a knowledge base;
performing a retrieval augmented generation operation, the retrieval augmented generation operation comprising constructing a retrieval augmented generation module, enabling the retrieval augmented generation module to perform an embedding transfer mechanism to generate a plurality of embedding vectors, and retrieving at least one of the embedding vectors and establishing a vector store, wherein the at least one of the embedding vectors is most relevant to the one of the industrial process monitoring system information and the nature language query information; and
performing a knowledge and information management operation, the knowledge and information management operation comprising constructing a knowledge and information management module, enabling the knowledge and information management module to manage the knowledge base and the vector store;
wherein the processor generates an answer corresponding to the one of the industrial process monitoring system information and the nature language query information according to the function and at least one of the embedding vectors.

2. The knowledge base system of claim 1, further comprising:
an industrial process monitoring system connected to the memory and the processor, and utilized to transmit the industrial process monitoring system information to the memory, the industrial process monitoring system comprising:
a data collection device connected to the memory and the processor, and comprising:
a cyber physical agent utilized to collect the industrial process monitoring system information; and
a user interface connected to the cyber physical agent, and utilized to collect the nature language query information and transmit the nature language query information to the memory through the cyber physical agent.

3. The knowledge base system of claim 2, further comprising:
a production line connected to the cyber physical agent of the data collection device, and comprising at least one equipment;
wherein the industrial process monitoring system monitors the at least one equipment of the production line through the cyber physical agent to generate the industrial process monitoring system information.

4. The knowledge base system of claim 2, wherein the industrial process monitoring system information comprises fault detection and classification alarm data, the industrial process monitoring system comprises a fault detection and classification system for a semiconductor bump process, the fault detection and classification alarm data comes from the fault detection and classification system of the semiconductor bump process, the nature language query information comprises a natural language query question from the user interface, the large language model comprises a generative pre-trained transformer, and any one of the specific domain function module, the retrieval augmented generation module, and the knowledge and information management module is a software module.

5. The knowledge base system of claim 2, wherein,
the processor receives the one of the industrial process monitoring system information and the nature language query information in one of a first method and a second method to form a demand layer, and the first method is different from the second method;
the processor forwards the one of the industrial process monitoring system information and the nature language query information to the specific domain function module or the retrieval augmented generation module according to a question dispatch mechanism to form a transfer layer; and
the processor performs the function calling mechanism or the embedding transfer mechanism to the one of the industrial process monitoring system information and the nature language query information according to the specific domain function module or the retrieval augmented generation module to form an application layer.

6. The knowledge base system of claim 5, wherein,
the first method comprises utilizing natural language for querying through the user interface to obtain a demand question; and
the second method comprises querying through an alarm of the industrial process monitoring system to obtain the demand question.

7. The knowledge base system of claim 2, wherein the specific domain function operation further comprises:
receiving the one of the industrial process monitoring system information and the nature language query information from a question dispatch mechanism through the user interface;
transmitting the one of the industrial process monitoring system information and the nature language query information to the function calling mechanism of the large language model in a data format through the user interface;
evaluating the function that can be used through the function calling mechanism of the large language model;
notifying the user interface of the function that can be used in the data format through the function calling mechanism of the large language model;
calling the function that can be used through the user interface, wherein the function that can be used is a fault detection and classification chart acquisition function;
receiving a return result through the user interface; and
sending the return result back to the question dispatch mechanism through the user interface;
wherein the data format comprises a JSON format.

8. The knowledge base system of claim 1, wherein the retrieval augmented generation operation further comprises:
performing an equipment manual retrieval, the equipment manual retrieval comprising performing the embedding transfer mechanism on an equipment manual according to the retrieval augmented generation module to generate an equipment manual vector of the embedding vectors;
wherein the embedding transfer mechanism further comprises converting text data into embedding vector data.

9. The knowledge base system of claim 8, wherein the retrieval augmented generation operation further comprises:
performing a question-answer retrieval, the question-answer retrieval comprising performing the embedding transfer mechanism on a question-answer pair data according to the retrieval augmented generation module to generate a question-answer vector of the embedding vectors;
wherein the vector store comprises the equipment manual vector and the question-answer vector of the embedding vectors, and the processor performs vector similarity search through the vector store to retrieve the answer corresponding to the one of the industrial process monitoring system information and the nature language query information.

10. A constructing method of a knowledge base system based on a large language model, comprising:
utilizing a processor to obtain the large language model and one of industrial process monitoring system information and nature language query information from a memory, wherein the industrial process monitoring system information is different from the nature language query information;
utilizing the processor to perform a specific domain function operation, the specific domain function operation comprising constructing a specific domain function module, enabling the specific domain function module to perform a function calling mechanism according to the large language model to generate a function corresponding to the one of the industrial process monitoring system information and the nature language query information, and establishing a knowledge base;
utilizing the processor to perform a retrieval augmented generation operation, the retrieval augmented generation operation comprising constructing a retrieval augmented generation module, enabling the retrieval augmented generation module to perform an embedding transfer mechanism to generate a plurality of embedding vectors, and retrieving at least one of the embedding vectors and establishing a vector store, wherein the at least one of the embedding vectors is most relevant to the one of the industrial process monitoring system information and the nature language query information; and
utilizing the processor to perform a knowledge and information management operation, the knowledge and information management operation comprising constructing a knowledge and information management module, enabling the knowledge and information management module to manage the knowledge base and the vector store;
wherein the processor generates an answer corresponding to the one of the industrial process monitoring system information and the nature language query information according to the function and at least one of the embedding vectors.

11. The constructing method of claim 10, further comprising:
utilizing an industrial process monitoring system to transmit the industrial process monitoring system information to the memory;
utilizing a cyber physical agent of a data collection device to collect the industrial process monitoring system information; and
utilizing an user interface of the data collection device to collect the nature language query information, and transmit the nature language query information to the memory through the cyber physical agent;
wherein the industrial process monitoring system is connected to the memory and the processor, the data collection device is connected to the memory and the processor, and the user interface is connected to the cyber physical agent.

12. The constructing method of claim 11, further comprising:
utilizing the industrial process monitoring system to generate the industrial process monitoring system information by monitoring at least one equipment of a production line through the cyber physical agent;
wherein the production line is connected to the cyber physical agent of the data collection device, and comprises the at least one equipment.

13. The constructing method of claim 11, wherein the industrial process monitoring system information comprises fault detection and classification alarm data, the industrial process monitoring system comprises a fault detection and classification system for a semiconductor bump process, the fault detection and classification alarm data comes from the fault detection and classification system of the semiconductor bump process, the nature language query information comprises a natural language query question from the user interface, the large language model comprises a generative pre-trained transformer, and any one of the specific domain function module, the retrieval augmented generation module, and the knowledge and information management module is a software module.

14. The constructing method of claim 11, further comprising:
utilizing the processor to receive the one of the industrial process monitoring system information and the nature language query information in one of a first method and a second method to form a demand layer, and the first method is different from the second method;
utilizing the processor to forward the one of the industrial process monitoring system information and the nature language query information to the specific domain function module or the retrieval augmented generation module according to a question dispatch mechanism to form a transfer layer; and
utilizing the processor to perform the function calling mechanism or the embedding transfer mechanism to the one of the industrial process monitoring system information and the nature language query information according to the specific domain function module or the retrieval augmented generation module to form an application layer.

15. The constructing method of claim 14, wherein the first method comprises utilizing natural language for querying through the user interface to obtain a demand question; and
the second method comprises querying through an alarm of the industrial process monitoring system to obtain the demand question.

16. The constructing method of claim 11, wherein the specific domain function operation further comprises:
receiving the one of the industrial process monitoring system information and the nature language query information from a question dispatch mechanism through the user interface;
transmitting the one of the industrial process monitoring system information and the nature language query information to the function calling mechanism of the large language model in a data format through the user interface;
evaluating the function that can be used through the function calling mechanism of the large language model;
notifying the user interface of the function that can be used in the data format through the function calling mechanism of the large language model;
calling the function that can be used through the user interface, wherein the function that can be used is a fault detection and classification chart acquisition function;
receiving a return result through the user interface; and
sending the return result back to the question dispatch mechanism through the user interface;
wherein the data format comprises a JSON format.

17. The constructing method of claim 10, wherein the retrieval augmented generation operation further comprises:
performing an equipment manual retrieval, the equipment manual retrieval comprising performing the embedding transfer mechanism on an equipment manual according to the retrieval augmented generation module to generate an equipment manual vector of the embedding vectors;
wherein the embedding transfer mechanism further comprises converting text data into embedding vector data.

18. The constructing method of claim 17, wherein the retrieval augmented generation operation further comprises:
performing a question-answer retrieval, the question-answer retrieval comprising performing the embedding transfer mechanism on a question-answer pair data according to the retrieval augmented generation module to generate a question-answer vector of the embedding vectors;
wherein the vector store comprises the equipment manual vector and the question-answer vector of the embedding vectors, and the processor performs vector similarity search through the vector store to retrieve the answer corresponding to the one of the industrial process monitoring system information and the nature language query information.
